(19) United States
(12) Patent Application Publication
(10) Pub. No.: US 2004/0210472 A1
(43) Pub. Date: Oct. 21, 2004

(54) System and method for conducting a real-time survey

(76) Inventors: Ark L. Lew, Ellicott City, MD (US); Martin E. Fraeman, Olney, MD (US); Binh Q. Le, Vienna, VA (US)

Correspondence Address: THE JOHNS HOPKINS UNIVERSITY, Applied Physics Laboratory, 11100 Johns Hopkins Road, Laurel, MD, 20723-6099, US

(21) Appl. No.: 10/626,154

(22) Filed: Jul. 24, 2003

Related U.S. Application Data
(60) Provisional application No. 60/398,393, filed on Jul. 25, 2002.

(51) Int. Cl. G06F 17/60

(52) U.S. Cl. 705/10

(57) ABSTRACT

A real-time feedback survey system and method allowing for responses to survey questions to be input by users and received by the surveyor in real-time is provided. This result is achieved by using a media player to provide a request for feedback information to a remote responding device, the remote responding device allowing response input and incorporating a transmitter for transmitting the response to a central facility.

### CROSS-REFERENCE TO RELATED APPLICATIONS

This application claims the benefit of prior filed co-pending U.S. Provisional Patent Application No. 60/398,393, filed Jul. 25, 2002, entitled “Real-Time Feedback for Media, Advertising and Other Surveying”, the contents of which are hereby incorporated by reference.

### BACKGROUND OF THE INVENTION

1. Field of the Invention

The present invention relates to a system for conducting a real-time survey. More particularly, the present invention relates to a system and method for acquiring real-time feedback for a media-related survey.

2. Description of the Related Art

Surveys, which tend to take the form of targeted questions that allow a user to evaluate a product, are extremely useful to both product sellers and product developers as a means of gauging demand in a particular group of potential customers. Surveys which are delivered electronically and allow an electronic response are particularly effective, because they allow for cheaper delivery of questions and rapid acquisition of results, and because they make response easier, meaning that people are more likely to reply.

Conventional electronic surveys take various forms. Such surveys use methods such as email messages, taped or live phone messages, or televised messages to distribute requests for feedback. Conventional survey methods then use a variety of input devices to gather response information, such as a keyboard, a phone number pad, a cable box, or an automated detector such as the device used by the Nielsen Company to gather ratings information.

One particularly effective means of transmitting surveys is to use a signal containing the survey which is modulated in an unobtrusive fashion (e.g. a high frequency above the human audible range) onto the audio content of a media transmission. Once a media player plays the audio, the survey signal is demodulated from the audio to allow a user to respond to the survey.

Unfortunately, prior art survey methods do not allow a respondent to input feedback using a device remotely situated from the device which displays or outputs the survey questions. Allowing a user to input feedback is clearly preferred, because the more feedback delivered to a surveyor, the more valuable the survey; the more information a surveyor has available, the more precisely the surveyor can respond to public opinion, or target product development or advertisement. Further, the more choice a respondent has regarding where the device allowing feedback is situated, the more convenient the act of response will be, and thus the more likely the respondent will be to provide feedback.

Further, prior art survey methods generally do not encrypt survey questions during delivery, meaning that a third party may be able to tamper with the questions. If the integrity of the survey questions is compromised, then the accuracy of the responses—and therefore, their usefulness—becomes doubtful.

Prior art survey methods also do not encrypt responses, meaning that a third party may be able to glean users' personal data, or even alter the responses to render them misleading.

### SUMMARY OF THE INVENTION

Accordingly, the present invention has been made to solve the above-mentioned problems occurring in the prior art, and an object of the present invention is to provide a system and method for conducting a real-time survey which allows the respondent to respond to survey questions at a location remotely spaced from the device which delivers the survey questions.

It is also an object of the invention to provide a system for conducting a real-time survey which allows the respondent to respond to survey questions modulated onto media content using a portable device which receives the survey questions from a media player, and which demodulates the survey questions from the media player.

It is also another object of the invention to provide a system for conducting a real-time survey which uses encrypted survey information to protect it from tampering by third parties and which encrypts feedback information to protect users' privacy and to protect the surveyor's proprietary interest in the feedback information.

It is a further object of the invention to provide a system for conducting a real-time survey which uses a positioning system such as, for example, GPS (Global Positioning System) to acquire location information related to feedback information, and a memory to store the location information and to allow the system to delay transmitting feedback information to a central facility for feedback information collation and analysis if necessary.

To accomplish these objects, according to a first embodiment of the present invention, there is provided a real time feedback survey system comprising a media player and a remote responding device. The media player includes a receiver for receiving media content containing a request for feedback information modulated onto the media content and a first display for providing an output of the media content to the user. The remote responding device includes a receiver for receiving the request for feedback information, a demodulator for demodulating the feedback information from the media content, a keypad for inputting feedback information, and a transmitter for transmitting the inputted feedback information to a central facility.

To accomplish these objects, according to a second embodiment of the present invention, there is provided a method for conducting a real time feedback survey, comprising the steps of: receiving, on a media player, media content containing a request for feedback modulated onto the media content; outputting the media content on the media player; receiving the media content containing a request for feedback modulated onto the media content at a remote responding device; demodulating, using the remote responding device, the request for feedback from the media content; inputting feedback information using the remote responding device; and transmitting the inputted feedback information from the remote responding device to a central facility.

To accomplish these objects, according to a third embodiment of the present invention, there is provided a real time feedback survey system comprising a media player and a remote responding device for responding to a request for feedback information. The media player includes means for receiving media content associated with the request for feedback information, a display for providing an output of the media content to the user, and a first transmitter for transmitting the request for feedback information. The remote responding device includes a receiver for receiving the request for feedback information, a keypad for inputting feedback information, and a second transmitter for transmitting the inputted feedback information to a central facility.

### BRIEF DESCRIPTION OF THE DRAWINGS

The above and other objects, features, and advantages of the present invention will be more apparent from the following detailed description taken in conjunction with the accompanying drawings, in which:

FIG. 1 is a block diagram of a system for conducting a real-time survey according to an embodiment of the invention;

FIG. 2 is a flow chart of a method for conducting a real-time survey according to an embodiment of the invention; and

FIG. 3 is a block diagram of a system for conducting a real-time survey according to an embodiment of the invention.

### DETAILED DESCRIPTION OF THE PREFERRED EMBODIMENTS

Preferred embodiments of the present invention will be described below with reference to the accompanying drawings. In the drawings, the same or similar elements are denoted by the same reference numerals even though they are depicted in different drawings. In the following description of the present invention, a detailed description of known functions and configurations incorporated herein will be omitted when it may make the subject matter of the present invention unclear.

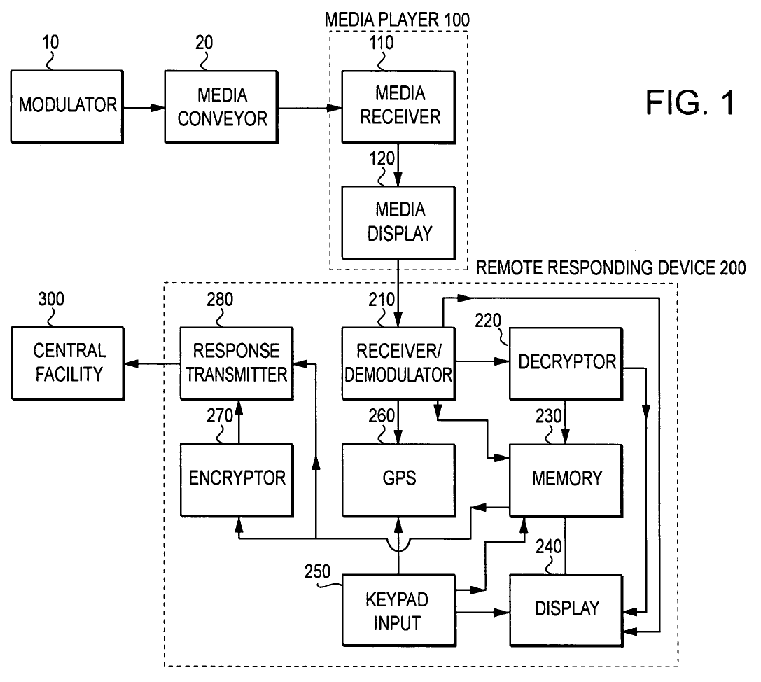

In a first embodiment of the present invention, referring to FIG. 1, a real-time survey system includes a media player 100 and a remote responding device 200.

The real-time survey system is configured to use survey information, provided by a surveyor, to solicit feedback information from a user; the feedback information is then transmitted to a central facility 300, where the surveyor can collate and analyze the feedback information.

The media player 100 includes at least a media receiver 110 and a media display 120.

Initially, a modulator 10 unobtrusively modulates survey information onto media content, producing a single media content signal prior to transmission. The media content may be any combination of audio and video content. Because media content is catered to human consumption, light and sound frequencies outside the range of human observation are left available for use in sending data. By modulating the survey information, as audio or video data, onto the media content in this available data range, the survey and the media content can be simultaneously output by a media display 120 of the media player 100. Thus, the remote responding device 200 can receive and demodulate the survey information from the media content signal without interrupting the user's enjoyment of the media content.

The survey information may include, for example, program coding information (requesting feedback regarding media programs displayed on the media player) and/or inquiry coding information (requesting feedback regarding advertising content displayed on the media player). Survey information may also include an identifier of the surveyor to discourage tampering.

A media conveyor 20, containing media content such as, for example, a radio transmission, a computer network such as the Internet, a DVD (Digital Versatile Disk), or a CD (Compact Disk), is used to convey the media content signal output by the modulator 10 to the media player 100. A media receiver 110 receives the media content and passes it on to a media display 120. The media receiver 110 and the media display 120 will both correspond to the type of media conveyor 20; that is, if the media conveyor 20 is a DVD, the media receiver 110 will be a DVD player, and the media display 120 will be a video display such as a television or computer screen. Similarly, if the media conveyor 20 is a CD, the media receiver 110 will be a CD player, and the media display 120 may be, for example, headphones or a speaker system. Other useful types of media receiver 110 include, but are not limited to, radio (receiving radio frequency transmissions), television (also receiving radio frequency transmissions), and MP3 (Moving Picture Experts Group) Layer-3 Audio player or other portable music player.

Because the media content signal played by the media display 120 contains the modulated survey information as well as the media content, the media display 120 is sufficient to transmit the survey information to the remote responding device 200.

The remote responding device includes a receiver/demodulator 210, a keypad input 250, and a response transmitter 280, and may optionally include any combination of a decryptor 220, a memory 230, a display 240, a GPS (Global Positioning System) 260, and an encryptor 270. Although, GP3 is used herein, the use of other positioning systems is envisioned.

The receiver/demodulator 210 includes a means for receiving the signal, such as a video camera, a microphone, or both, enabling the remote responding device to monitor the media content signal for portions of the signal containing modulated survey information. The receiver/demodulator 210 also includes circuitry for extracting the survey information from the media content signal. There should be no signal in the available data range mentioned above when there is no data being transmitted, in which case the receiver/demodulator 210 will only demodulate the media content signal when it contains modulated survey information. If there is a signal in the available data range even when there is not data being transmitted, the receiver/demodulator 210 may continuously demodulate the media content signal to seek portions of the media content signal containing survey information.

The responding device 200 is preferably portable, and may be wearable, so that the user is not constrained to a single location in order to respond to a survey. The device 200 may include a display 240, such as an LCD (Liquid Crystal Display) or LED (Light Emitting Diode) display, with which to display the questions and instructions included in the survey information. Alternatively, if the responding device 200 does not include a display 240, the media display 130 must display the questions and instructions.

If the integrity of the survey information is protected by encryption, the responding device 200 must include a decryptor 220 to decrypt the survey information before it may be displayed and before the user may input feedback information.

The responding device may also include an encryptor 270 to encrypt feedback information prior to transmission to the central facility 300. Encrypting feedback information prevents third parties from breaching a user's privacy by exploiting the user's feedback information without the user's permission, and also prevents third parties from exploiting the feedback information without the surveyor's permission.

Both the decryptor 220 and the encryptor 270 may be implemented in hardware such as, for example, SSI (Small Scale Integration) or MSI (Medium Scale Integration) logic circuitry, EPROM (Eraseable Programmable Read Only Memory) or FPGA (Field Programmable Gate Array). Alternatively, the decryptor 220 and the encryptor 270 may be implemented as software on a microprocessor such as a CPU (Central Processing Unit) or DSP (Digital Signal Processor). The decryption and encryption may use any secure encryption method, for example a secret-key method such as DES (Data Encryption Standard), or a public-key method such as RSA (Rivest, Shamir, and Adleman).

The user inputs responses to the questions contained by the request for feedback on the keypad 250. The keypad 250 may include alphabetical, numerical, and/or function keys, depending on the type of device in which the remote responding device 200 is included and the types of questions which the vender of the responding device wishes to enable users to answer. For example, if the responding device 200 is included in a laptop computer, the keypad 250 may be a keyboard with a complete set of alphanumeric and function keys; if the responding device 200 is included in a cellular telephone, the keypad 250 will likely include a set of alphanumeric keys each of which are capable of inputting multiple alphanumeric characters, as well as a set of function keys; and if the responding device 200 is implemented in a PDA, the keypad 250 may be implemented as a set of touch-sensitive locations on the PDA's display.

In another embodiment, the remote responding device 200 may optionally include a memory 230. A memory 230 allows users to, for example, review their inputted feedback information, to respond to survey information long after it is received. A memory 230 also allows the remote responding device 200 to transmit feedback information in a lump after it is entered, or, if necessary, to wait to transmit if no stable data connection to the central facility 300 is currently available. The memory 230 is useful when the responding device is portable. Further, use of a memory allows a responding device to acquire location information using a GPS 260, thus giving the surveyor further information with which to target development and advertising of products. The GPS 260 may acquire location information of the responder when the request for feedback is received, when the feedback information is inputted, or both, depending on the type of location information the surveyor is interested in.

When transmitted, feedback information should include data identifying the particular set of survey information to which the feedback information is related. Such data may include, for example, time of survey information receipt, television or radio channel which survey information was received from, or an identifier of the program which carried the survey information.

Depending in part on the nature of the remote responding device (e.g. laptop, PDA, or cellular telephone), the response transmitter 280 may be, for example, a network card for connecting to a network connection (e.g. for connecting to the Internet); a modem; a combination between a device for interfacing with a cradle adapted to receive the remote responding device 200, and a modem or network card built into the cradle; a wireless network device; or a wireless network device for transmitting to a modem which transmits to the central facility 300.

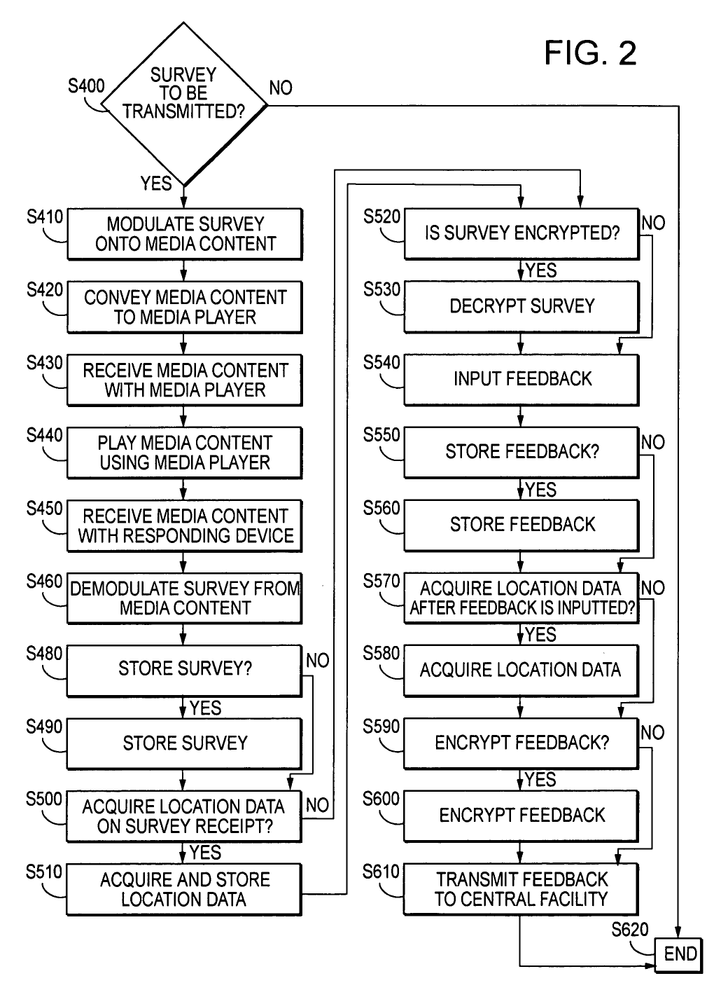

FIG. 2 is a flow chart of an embodiment of the present invention, comprising a real-time survey method. The real-time survey method commences when a new survey to be transmitted is generated, at step S400.

At step S410, the survey is modulated onto media content. Then, at step S420, the media content, on which a survey is now modulated, is conveyed to a media player, which receives the media content at step S430. At step S440, the media .display of the media player proceeds to output, or play, the media content, which the responding device receives at step S450 and demodulates at step S460.

Subsequently, if memory is provided, the responding device decides at step S480 whether to store the survey. The decision depending on whether storage is desired (by the surveyor or user) or necessary (to facilitate delayed feedback input). If the responding device decides to store, storage occurs at step S490 and the method proceeds to step S500. If the responding device has no memory or decides not to store, storage does not occur, and the method proceeds to step S500.

The responding device decides at S500 whether to acquire location data immediately after receipt of the survey, if the device is provided with GPS or other means to gather location data. If the device has a means of gathering location data, and if location data acquisition is either a default, or the user or the surveyor has instructed the responding device to gather location data, then location data is gathered and stored at step S510 and the method proceeds to S520. Otherwise, no location data is acquired and the method proceeds to step S520.

At step S520, the responding device detects whether the survey is encrypted. If the survey is encrypted, the device decrypts the survey at step S530 and proceeds to step S540; otherwise, the method proceeds to step S540.

At step S540, the user may input feedback. At step S550, the responding device may decide to store feedback if the device contains a memory. This decision may be based on, for example, whether the user wishes to be able to edit the feedback before transmission and whether the device will immediately be able to transmit the completed feedback information to the central facility. If the responding device decides to store, storage occurs at step S560. Whether or not the device stores feedback information, the method then proceeds to step 570.

At step S570, the responding device decides whether to acquire location data to be associated with the time at which feedback is inputted. The reasoning behind this is the same as with step S500. Acquisition and storage of location data corresponding to feedback input occurs at step S580; the method then proceeds to step S590, whether or not location data is acquired.

Encryption of feedback protects the privacy of a user's feedback information against third parties and also prevents third parties from appropriating the surveyor's proprietary feedback information. The decision to encrypt occurs at step S590; encryption occurs at step S600 if encryption is desired. Whether or not encryption occurs, the method then proceeds to step S610.

At step S610, all feedback, along with any stored location data, is transmitted to the central facility. The method then proceeds to step S620, where the survey ends.

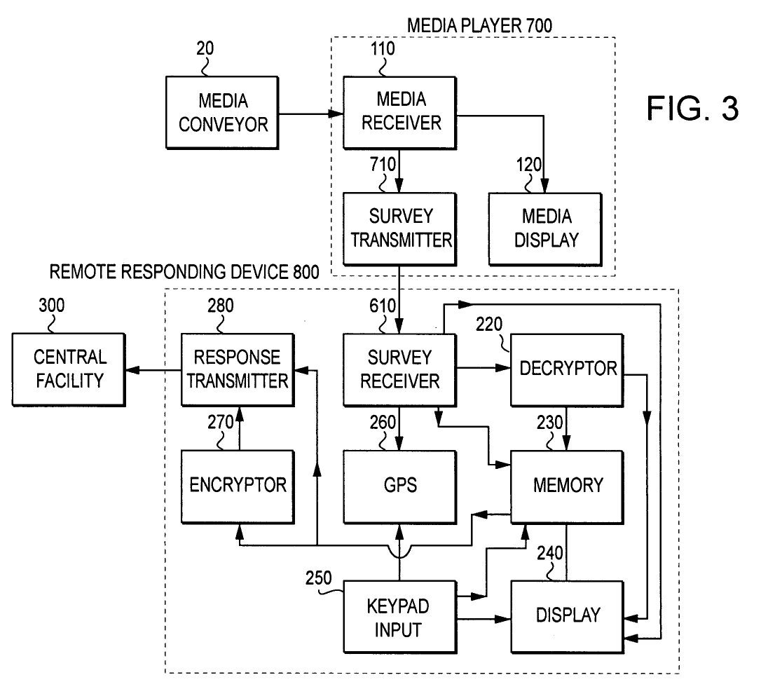

In another embodiment of the present invention, referring to FIG. 3, a real-time survey system includes a media player 700 and a remote responding device 800.

The real-time survey system is configured to use survey information, provided by a surveyor, to solicit feedback information from a user; the feedback information is then transmitted to a central facility 300, where the surveyor can collate and analyze the feedback information.

A media player 700 is comprised of a media receiver 110, a survey transmitter 710, and a media display 120. The media receiver 110 and the media display 120 operate as described above.

A media conveyor 20 containing media content and survey information is received by a media receiver 110 of a media player 700. The media receiver 110 sends the media content to a media display 120, which outputs or plays the media content for a user. The media receiver 110 sends the survey information to a survey transmitter 710 to be transmitted to the remote responding device 800.

The survey transmitter may transmit to the remote responding device in either a wired or a wireless manner. A wireless transmitter may use, for example, an 802.11b protocol or a CDMA protocol, while a wired transmitter might use, for example, a LAN (Large Area Network) or modem connection. The characteristics of the survey transmitter should be determined by the amount of freedom allowed in movement of the responding device and the content of the request for feedback to be transmitted. If the remote responding device includes a display, and the survey information includes display data, and particularly if the survey information includes pictures or other memory-intensive data, the transmitter should use a high-bandwidth protocol for transmission. Otherwise, a low-bandwidth protocol may be preferred, because bandwidth often correlates to expense and bulk in production of devices with communication components.

The remote responding device 800 is comprised of a survey receiver 810, a keypad input 250, and a response transmitter 280. The responding device 800 optionally includes a decryptor 220, a memory 230, a display 240, a GPS 260, and an encryptor 270. The decryptor 220, the memory 230, the display 240, the GPS 260, the encryptor 270, and the response transmitter 280 operate as described in the first embodiment.

The survey receiver 810 may use a receiver version of the hardware and protocol used by the survey transmitter, or may include a range of hardware and protocol compatibilities to allow communication with a variety of survey transmitter 710 implementations.

While the invention has been shown and described with reference to certain preferred embodiments thereof, it will be understood by those skilled in the art that various changes in the form and details may be made therein without departing from the spirit and scope of the invention as defined by the appended claims.

What is claimed is:

1. A real time feedback survey system comprising:
a) a media player having a receiver for receiving media content containing a request for feedback information modulated onto the media content, and a first display for providing an output of the media content to the user; and
b) a remote responding device having
a receiver for receiving the media content containing a request for feedback information modulated onto the media content information,
a demodulator for demodulating the feedback information from the media content;
a keypad for inputting feedback information, and
a transmitter for transmitting the inputted feedback information to a central facility.

2. The system of claim 1, further comprising:
means for modulating a request for feedback information onto media content; and
means for conveying the media content and the modulated request to the media player.

3. The system of claim 1, further comprising:
a decryptor for decrypting the request for feedback information to produce a decrypted request for feedback information, the decryptor being incorporated into the responding device,
wherein the request for feedback information is encrypted.

4. The system of claim 1, further comprising:
an encryptor for encrypting the inputted feedback information prior to transmission by the transmitter, the encryptor being incorporated into the responding device.

5. The system of claim 1, further comprising:
a second display for displaying the request for feedback information, the display being incorporated into the responding device,
wherein the request for feedback information includes display data which the display uses to display the request for feedback information.

6. The system of claim 1, further comprising:
a memory for storing the inputted feedback information, the memory being incorporated into the responding device.

7. The system of claim 6, further comprising:
a positioning system receiver for acquiring location data, the positioning system receiver being incorporated into the responding device,
wherein the memory further stores the location data, and
wherein the transmitter concurrently transmits the location data and the feedback information.

8. The system of claim 7,
wherein the positioning system receiver acquires the location data when the user inputs the feedback information.

9. The system of claim 7,
wherein the positioning system receiver acquires the location data when the responding device receives the request for feedback information.

10. The system of claim 6, further comprising:
a cradle for receiving the responding device, the cradle including a modem for transmitting inputted feedback information to a central location,
wherein the transmitter is adapted to transmit feedback information to the modem included in the cradle.

11. The system of claim 6,
wherein the responding device is portable.

12. The system of claim 11,
wherein the responding device is incorporated into a mobile communications terminal which is comprised of at least one of a laptop, a Personal Digital Assistant (PDA), and a cellular telephone.

13. The system of claim 3,
wherein the responding device is incorporated into a mobile communications terminal which is comprised of at least one of a laptop, a Personal Digital Assistant (PDA), and a cellular telephone, and
wherein a processor of the at least one of a laptop, a PDA, and a cellular telephone includes the decryptor of the responding device.

14. The system of claim 4,
wherein the responding device is incorporated into a mobile communications terminal which is comprised of at least one of a laptop, a Personal Digital Assistant (PDA), and a cellular telephone, and
wherein a processor of the at least one of a laptop, a PDA, and a cellular telephone includes the encryptor of the responding device.

15. The system of claim 2,
wherein the means for conveying includes at least one of a radio frequency transmitter, a network, a DVD, or a CD.

16. The system of claim 12,
wherein the at least one media player includes at least one of a television, a stereo system, a radio, a portable music player, a DVD player, a CD player, MP3 player and a computer.

17. The system of claim 1,
wherein the request for feedback information includes at least one of program coding information and inquiry coding information.

18. A method for conducting a real time feedback survey, comprising the steps of:
receiving, on a media player, media content containing a request for feedback modulated onto the media content;
outputting the media content on the media player;
receiving the media content containing a request for feedback modulated onto the media content at a remote responding device;
demodulating, using the remote responding device, the request for feedback from the media content;
inputting feedback information using the remote responding device; and
transmitting the inputted feedback information from the remote responding device to a central facility.

19. The method of claim 18, further comprising the steps of:
modulating a request for feedback onto media content; and
conveying the media content to a media player suitable for playing the media content.

20. The method of claim 18, further comprising the step of:
decrypting the request for feedback information using a decryptor of the remote responding device to produce a decrypted request for feedback information;
wherein the request for feedback information is encrypted.

21. The method of claim 18, further comprising:
encrypting the inputted feedback information using an encryptor of the remote responding device prior to the step of transmitting the inputted feedback information.

22. The method of claim 18,
wherein the request for feedback is comprised of at least one of program coding survey information and inquiry coding survey information.

23. The method of claim 18, further comprising the step of:
displaying the request for feedback information on a display of the responding device,
wherein the request for feedback information includes display data used by the display to display the request for feedback information.

24. The method of claim 18, further comprising the step of:
displaying the request for feedback information using the media player,
wherein the media content includes a request for feedback information.

25. The method of claim 18, the feedback transmitting step further comprising the steps of:
transmitting the inputted feedback information to a cradle adapted to receive the responding device;
transmitting the inputted feedback information from the cradle to the central facility.

26. The method of claim 18, further comprising the step of:
acquiring location data using a positioning system receiver of the responding device,
wherein the feedback transmitting step further comprises transmitting the location data concurrently to transmitting the feedback information.

27. The method of claim 26,
wherein the acquiring step is performed when the user inputs the feedback information.

28. The method of claim 26,
wherein the acquiring step is performed when the responding device receives the encrypted request for feedback.

29. The system of claim 18, the feedback transmitting step further comprising the step of:
wirelessly transmitting the feedback information to a modem for transmission to the central facility.

30. A real time feedback survey system comprising:
a) a media player, which includes
means for receiving media content associated with a request for feedback information,
a display for providing an output of the media content to the user, and
a first transmitter for transmitting the request for feedback information to a remote responding device for responding to the request for feedback information; and
b) the remote responding device, which includes
a receiver for receiving the request for feedback information,
a keypad for inputting feedback information, and
a second transmitter for transmitting the inputted feedback information to a central facility.
